(19) United States
(12) Patent Application Publication
(10) Pub. No.: US 2008/0196225 A1
(43) Pub. Date: Aug. 21, 2008

(54) Interment container

(76) Inventors: David D. Pruitt, San Jose, CA (US); Wayne S. Hossenlopp, San Jose, CA (US)

Correspondence Address: WAYNE HOSSENLOPP, 6672 MT. PAKRON DR., SAN JOSE, CA, 95120, US

(21) Appl. No.: 11/708,971

(22) Filed: Feb. 21, 2007

(51) Int. Cl. A61G 17/00

(52) U.S. Cl. 27/10; 27/1

(57) ABSTRACT

An interment container comprising at least one protrusion or at least one indentation, the protrusion or indentation being configured to approximately align with, engage with, or couple to at least one corresponding protrusion or indention of another interment container. The interment container may be configured to comprise at least one protrusion or indentation on any portion of the interment container. Also, a key or intermediate member may be used to approximately align, engage, or couple with corresponding indentations located on stacked, adjacent, proximate, or arranged interment containers.

### FIELD

This invention relates to interment vessels or interment containers to be used in mausoleums or crypts, and more particularly to an interment container design configured to aid or facilitate the arrangement of a plurality of interment containers.

### BACKGROUND

A crypt and/or or mausoleum is typically a location or place having a collection of interment spaces where deceased bodies are stored or may be potentially stored below ground level (for a crypt), or above ground level (for a mausoleum). An interment container may store or may potentially store a deceased body, a coffin, or a casket containing a deceased body and may be used for long-term entombments or storage as well as dis-interment, transport, or re-interment. The interment container may be used to store a deceased human or animal.

Mausoleums are above-ground structures that provide a plurality of vaults or chambers for entombment of corpses. A burial casket, usually constructed of wood or other materials, is typically inserted through an opening in one wall of the mausoleum into a chamber and the chamber is sealed with a cover or end-plate arrangement. The cover usually comprises a marble face or granite plate that bears the name and dates of the deceased. A crypt is similar to a mausoleum, but a crypt facility is typically built or inserted below the ground level.

The conventional way to construct a mausoleum or crypt is using integrally, cast-in-place concrete with an egg crate style formwork. This produces a series of rows and columns of cells, typically known as a mausoleum or crypt bank.

A method commonly employed to construct mausoleums and crypts involves erecting forms at the site and then pouring concrete into the forms, to form walls or a portion of a storage structure. After the concrete has cured, the forms are removed from the walls and then may be re-erected and the process is repeated for each level or area that is desired. There are a number of problems with this type of construction. First, cracking of the concrete takes place due to shrinkage. Furthermore, a standard mausoleum building tends to settle. This leads to leakage of both fluid and gases from the mausoleum or crypt enclosure.

It is also important to maintain precise alignment on the front face of the mausoleum or crypt bank in order to ensure proper sealing and an aesthetic visual appearance. This is very difficult to do with cast in place concrete which shrinks and settles over time as mentioned above. In addition, settlement and shrinkage causes marble facing panels to loosen. This is unsightly and also produces leaks around the front face seal. Also, during seismic activity joints can be easily skewed resulting in leakage and unsightly geometric lines.

The manufacturers of mausoleums are also faced with other challenges. For example, over time caskets can deteriorate and emit body fluids and gases. Thus, to prevent perceptible leakage of odoriferous fluids and gasses from the mausoleum, each chamber must be provided with a vent and drainage system. In conventional construction methods, drain/vent pipes are installed within the wall forms and the concrete is then poured around them. Such installation process is time consuming and expensive. Furthermore, a drain/vent pipe is susceptible to becoming damaged during the pouring of the concrete. In severe cases, the pipe can snap rendering it useless for draining/venting purposes. In other installations, such pipes are supported along the wall exteriors.

Thus, there is a need for mausoleums and crypt designs that may be more economical, and/or easier to construct and assemble.

### BRIEF DESCRIPTION OF THE DRAWINGS

The invention may best be understood by referring to the following description and accompanying drawings that are used to illustrate exemplary embodiments of the invention. In the drawings:

FIG. 1A is a cross sectional end view of an exemplary interment container.

FIG. 1B is a top view of the exemplary interment container of FIG. 1A.

FIG. 1C is a cross sectional end view of another interment container stacked on top of the exemplary interment container of FIG. 1A.

FIG. 2 is a cross section of a plurality of exemplary interment containers stacked in multiple rows and columns.

FIG. 3A is a cross sectional end view of another exemplary embodiment of an interment container.

FIG. 3B is a cross sectional end view of the exemplary interment container of FIG. 3A, having coupled upper and lower members.

FIG. 3C is a cross sectional end view of another exemplary embodiment of an interment container.

FIG. 3D is a cross sectional end view of the exemplary interment container of FIG. 3C, having coupled upper and lower members.

FIG. 3E is a view of a plurality of portions or members which are used to form a top, bottom, and sidewalls (a single sidewall is shown) of another exemplary embodiment of an interment container.

FIG. 3F is an orthogonal view assembly of the exemplary interment container portions of FIG. 3E.

FIGS. 3G-H are an orthogonal views of existing interment container having exemplary modifications providing indentations and protrusions to the existing interment container.

FIGS. 4A-4E are top views of a variety of exemplary interment containers, each interment container comprising optional patterns of protrusions and indentations.

FIGS. 5A-B are cross sectional end views of other exemplary embodiments of interment containers.

FIG. 6A is an orthogonal view of another exemplary embodiment of an interment container.

FIG. 6B is a cross sectional A-A view of the exemplary indentation of the interment container of FIG. 6A, and an intermediate member.

FIG. 6C is an orthogonal view of another exemplary embodiment of an interment container.

FIG. 6D is a cross sectional view of the exemplary indentation of the interment container of FIG. 6A, and an intermediate member.

FIG. 6E is a top view of a plurality of exemplary interment containers, each interment container comprising exemplary corner indentations.

FIG. 6F is an orthogonal view of the exemplary interment container of FIG. 6E.

FIG. 7 is a cross sectional view of a plurality of exemplary interment containers arranged into rows and columns, the interment containers comprising the exemplary features of the embodiments of FIGS. 6C-D and FIGS. 6E-F.

### DETAILED DESCRIPTION

An interment container may be configured to have at least one open end or surface, where the open end is used to receive a coffin, casket, or vessel containing a deceased body for storage. After a coffin or deceased body has been inserted or placed into the interment container, the interment container is typically sealed to provide an airtight or fluid tight sealed structure. For example, the interment container may be sealed using adhesives, flanges, gaskets, tapes, liners, or other means. Decomposition of the deceased body and/or coffin will most likely produce gases or vapors. Optionally, the interment container may also comprise or include a pressure relief means or system in the form of a check valve, pressure valve, or the interment container may be coupled to other ventilation systems capable of venting gases or vapors and/or or drainage systems for draining fluids or liquids.

An interment container is dimensionally and structurally configured to contain or store a coffin or a casket containing a deceased body. The interment container may generally have a split construction or be comprised of a plurality of portions, partitions, or members which form a top (or cover), bottom (or tray), sidewalls, end cap(s) (or end walls), portions, or sections that, when fit or coupled together, define an internal recess or internal cavity area that is configured to receive the remains of a deceased body in a coffin. Generally, split construction pieces or members of the interment container are positioned, aligned, assembled, engaged, coupled, attached, secured, locked, bonded, or sealed together to form, build, or construct the interment container. Each interment container may be also constructed as a first piece comprising a combination of sides, a closed end, a top or upper portion, or a bottom or lower portion, and a second piece or third piece configured to enclose the coffin or remains. An interment container may also comprise an open end configured to receive, engage, or couple to a removable and/or sealable end cover. A plurality of interment container members, molds, or structural pieces may be prefabricated, shipped to a particular location, and then formed or assembled on-site.

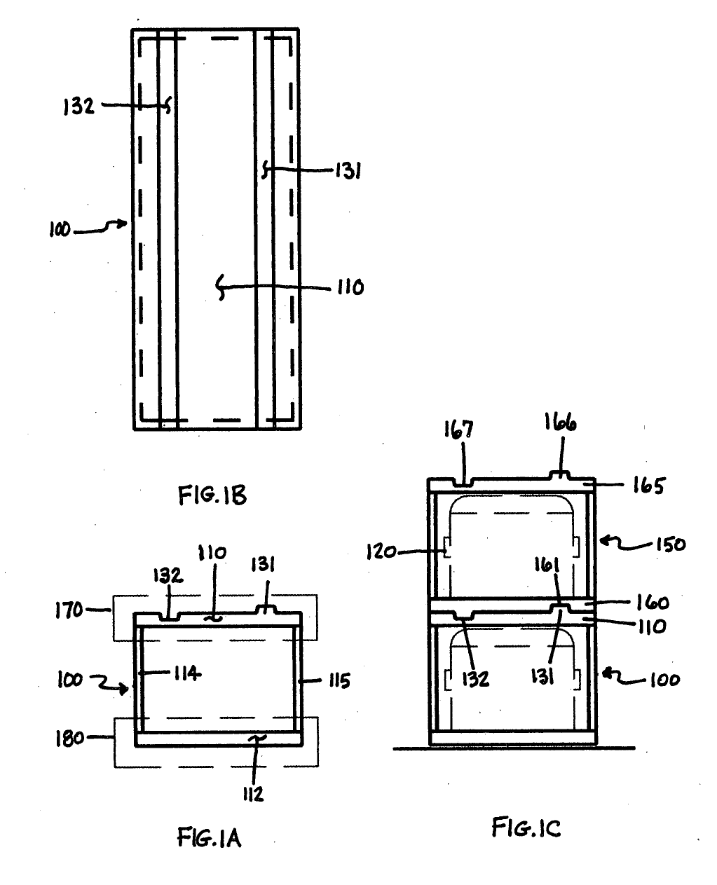

Referring to FIG. 1A, an exemplary embodiment of an interment container 100 comprises an upper portion 170 or upper surface, and a lower portion 180 or lower surface. The interment container 100 also may comprise an upper member 110, a lower member 112, and two side walls 114, 115. In this embodiment, the interment container 100 upper portion 170 comprises at least one protrusion 131, such as a bump, raised, or elevated feature. Also in this embodiment, the upper portion 170 comprises at least one optional indentation 132, such as a channel or depression feature. The (first) interment container 100 protrusion 131 is configured or positioned to align, engage, mate, or couple with a corresponding indentation of another (or second) interment container. Alternatively, the (first) interment container 100 upper portion 170 may comprise an indentation 132 feature configured to align, engage, mate, or couple with a corresponding protrusion feature of another (or second) interment container.

Referring to FIG. 1B, the exemplary interment container 100 comprised the protrusion 131, and indentation 132 in which each feature (131, 132) is configured as a rail or slot that runs the overall length of the upper portion, top surface, or upper member 110 of the interment container 100.

Exemplary interment containers may be stacked into columns, arranged in rows, or arranged in a repeating cell pattern. Referring to FIG. 1C, a lower interment container 100 protrusion 131 aligns with an upper interment container 150 indentation 161 to form a stack or column of interment containers 100, 150. The alignment of a first container protrusion 131 with a second container indentation 161 provides a design and method to align, engage, mate, or couple a plurality of interment containers to form a stack or column, and the protrusion or indentation in alignment is also configured to resist or reduce physical movement between the stacked, adjacent, or proximate interment containers 100, 150. Each interment container is generally of sufficient rigidity or strength to form a sustaining base for other interment containers stacked above it. The upper interment container 150 also comprises an upper member 165 (or upper portion) protrusion 166, and upper member 165 (or upper portion) indentation 167, each configured to engage or align with another interment container to facilitate stacking a plurality of interment containers to form a column of interment containers. Each interment container 100, 150 is dimensionally and structurally configured to contain or store a coffin 120 or a casket containing a deceased body for storage. Alignment, engagement, or coupling of interment container protrusions or indentations may aid or facilitate in the arrangement of a plurality of interment containers into columns, into rows, or into a repeating cell pattern.

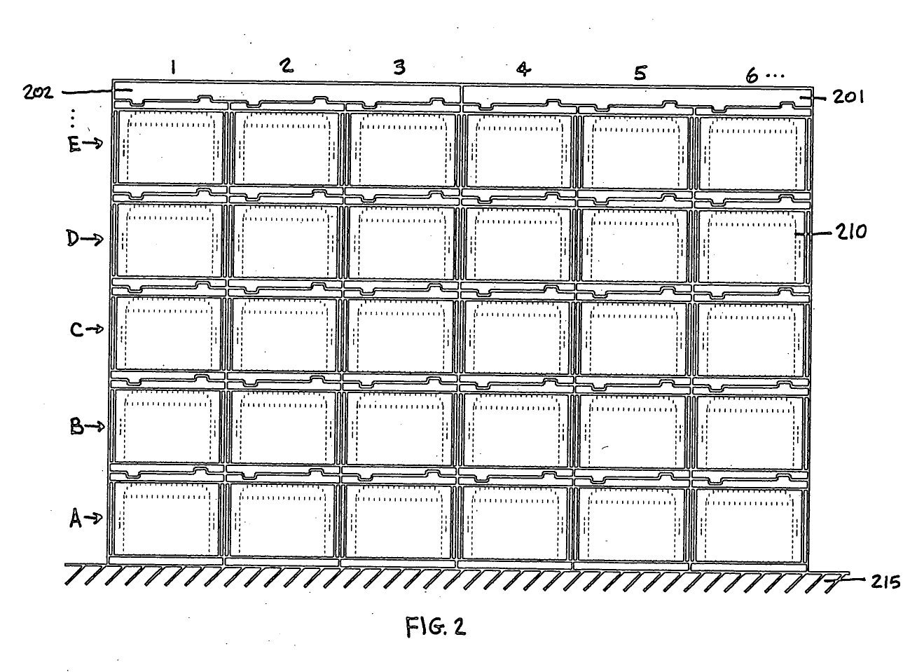

A protrusion feature or indentation feature may aid or facilitate in forming or building an interment (storage) area while avoiding the typical use of extensive forms to build standard concrete structures. Referring to FIG. 2, a plurality of interment containers may be arranged into a plurality of rows (for example, A-E) and a plurality of columns (for example, 1-6), forming a repeating storage structure or cell pattern. The arrangement of interment containers may be used to form a mausoleum or crypt like storage area. Examples of storage areas include above-ground or underground facilities, such as mausoleums, crypts and catacombs, single or multiple story buildings, and/or any structure or building used to store a collection of cells or containers, where a plurality of interment containers are configured to potentially store or hold coffins and deceased bodies.

An exemplary bottom row of interment containers (row A) have no indentations or protrusions on the lower portion of each container. As an option, any interment container in the first row (A) may be approximately identical in design to interment containers in other rows (BE) comprising at least one indentation or at least one protrusion located on the lower portion of the interment container. A supporting surface 215, such as a floor or supporting structure, may be flat or optionally comprise corresponding indentations or protrusions configured to engage with protrusions or indentations of any interment container(s) in the first, bottom, or lowest row (A). An optional member 201, 202 comprising a plurality of corresponding protrusions or indentations, spans more than one interment container. The optional member protrusion(s) or indentation(s) align with or engages with at least one interment container protrusion or indentation within a row or column of interment containers. Furthermore, this engaging member 201, 202 is optionally attached or coupled to a structure or other item (not shown), such as a column, a wall, a floor, a support beam, or a stabilizing member.

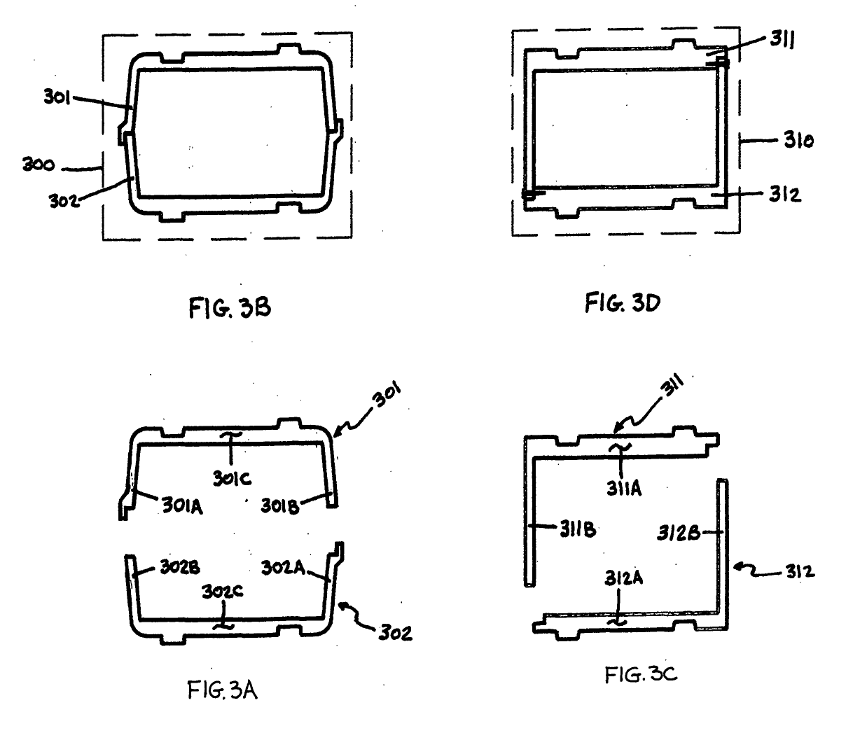

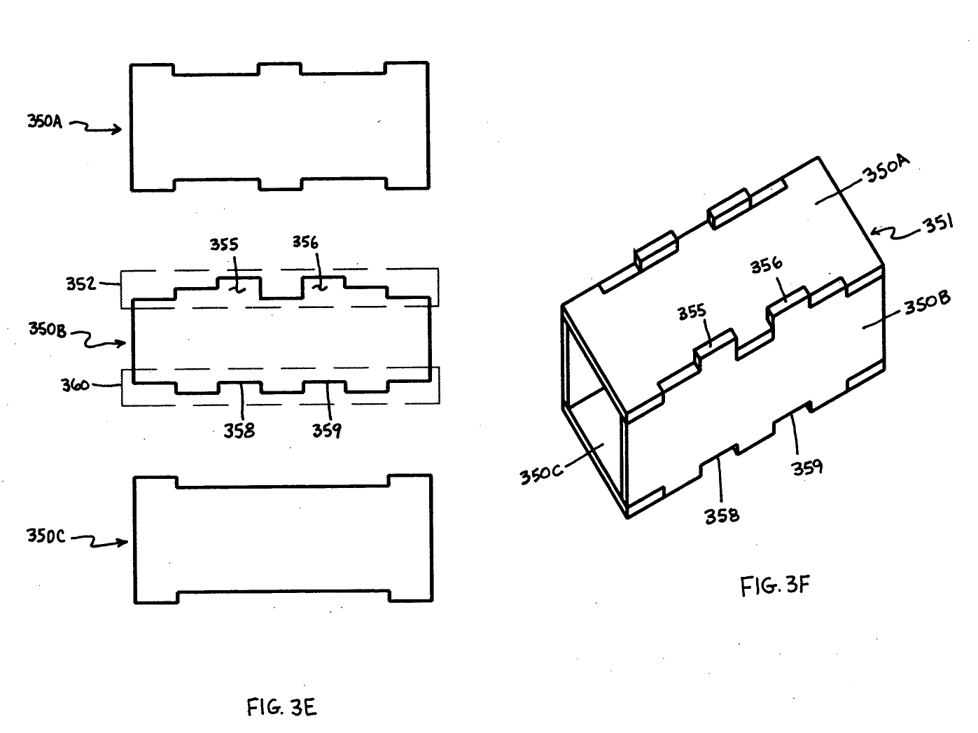

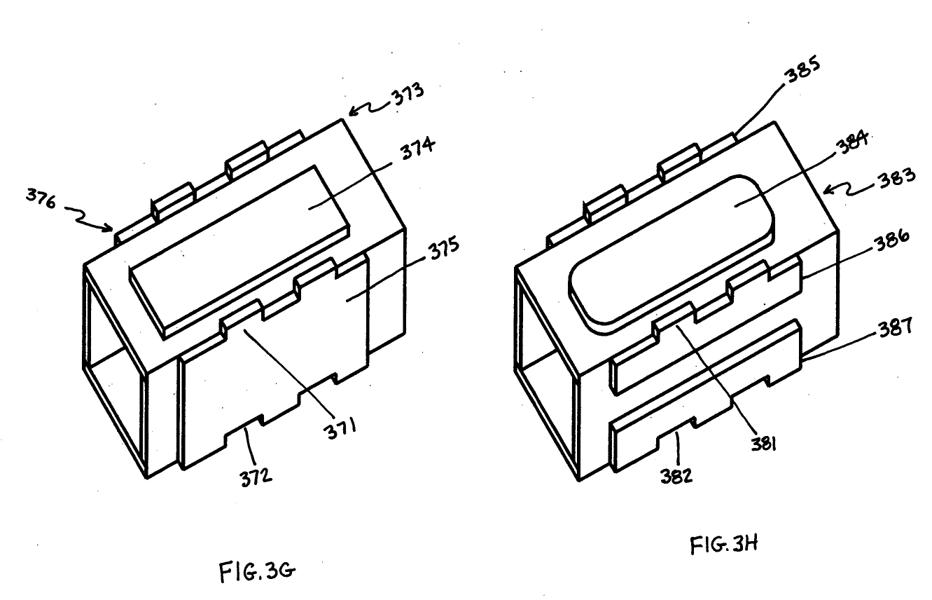

Other exemplary embodiments of interment containers may comprise a split construction that further comprises a member that may comprise or include a portion of one or more sidewalls or may also include a portion of one or more end caps. For example, a single upper member may comprise or include a portion of a least one side wall. Referring to FIG. 3A-B, another exemplary embodiment of an interment container comprises an upper member 301 (or cover) as a single part or member, and a lower member 302 (or base) as a single part or member. The upper member 301 further comprises an upper (or top) portion 301C and at least some portion of an interment container side wall 301A, 301B. The lower member 302 further comprises a lower portion 302C and at least some portion of an interment container side wall 302A, 302B. Referring to FIG. 3B, the upper member 301 and lower member 302 may be coupled, attached, or bonded in a variety of means to form the top, bottom, and side walls of an interment container 300. In this particular embodiment of an interment container 300, the interment container upper member 301 has cross sectional design that is similar to or approximately identical to the interment container lower member 302. An end cap may be coupled to any upper or lower member of the interment container to further form an interior recess or cavity.

Referring to FIG. 3C, another exemplary embodiment of an interment container comprises an upper member 311 as a single part or member, and a lower member 312 as a single part or member. The upper member 311, further comprises an upper (or top) portion 311A and at least some portion of an interment container side wall 311B. The lower member 312 further comprises a lower (or bottom) portion 312A and at least some portion of an interment container side wall 312B. Referring to FIG. 3D, the upper member 311 and lower member 312 are coupled, attached, or bonded in a variety of means to form the top, bottom, and side walls of an interment container 310. The upper member 311 and a lower member 312 may be attached to form an interment container 310, for example by using screws (see FIG. 3D) or bolts, or by using keys, or a variety of methods or means including flanges (see FIGS. 3A and 3B), adhesives, glues, or caulking. In this particular embodiment, the upper container member 311 has cross sectional design that is similar to or approximately identical to the lower container member 312.

Referring to FIG. 3E, other exemplary embodiments using a variety of members 350A, 350B, 350C configured to provide engaging, aligning, or inter-locking protrusion or indentation features are considered to be equivalent embodiments. A sidewall member 350B comprises at least one protrusion 355 (or 356), and/or comprises at least one corresponding indentation 358 (or 359) in an upper portion 352, in a lower portion 360, or in a side portion (not shown) of the interment container. Referring to FIG. 3F, the top member 350A, bottom member 350C, and side members 350B are assembled, engaged, or coupled to provide an interment container 351. The interment container may be stacked, arranged, or aligned with another similar or approximately identical interment container having corresponding protrusions 355, 356 or indentations 358, 359.

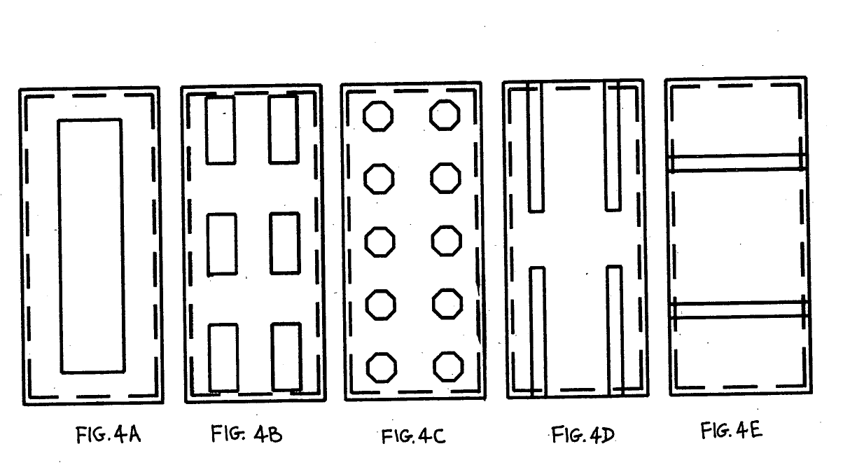

A variety of exemplary protrusion or indentation patterns may be used to align or engage upper and lower portions, adjacent portions, or proximate portions of interment containers. Referring to FIGS. 4A-E, a variety of exemplary protrusion and/or indentation patterns or arrangements may be configured or embodied in upper, lower, or side, or any portion of an interment container, including but not limited to convex/concave bumps, depressions, rectangles, circular patterns, and/or a variety of other shapes. A protrusion or indentation feature of a first interment container is configured to align or engage with a corresponding protrusion or indentation feature of another (above, below, adjacent, or proximate) interment container. At least one protrusion or at least one indentation is configured to engage, align, or couple a plurality of interment containers into stacks, columns, rows, or in a repeating cell pattern.

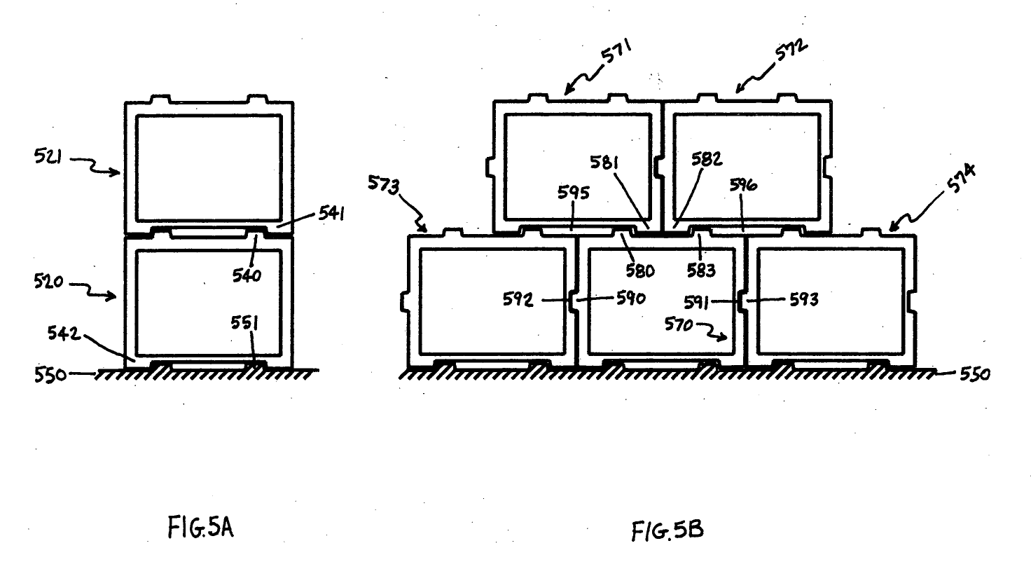

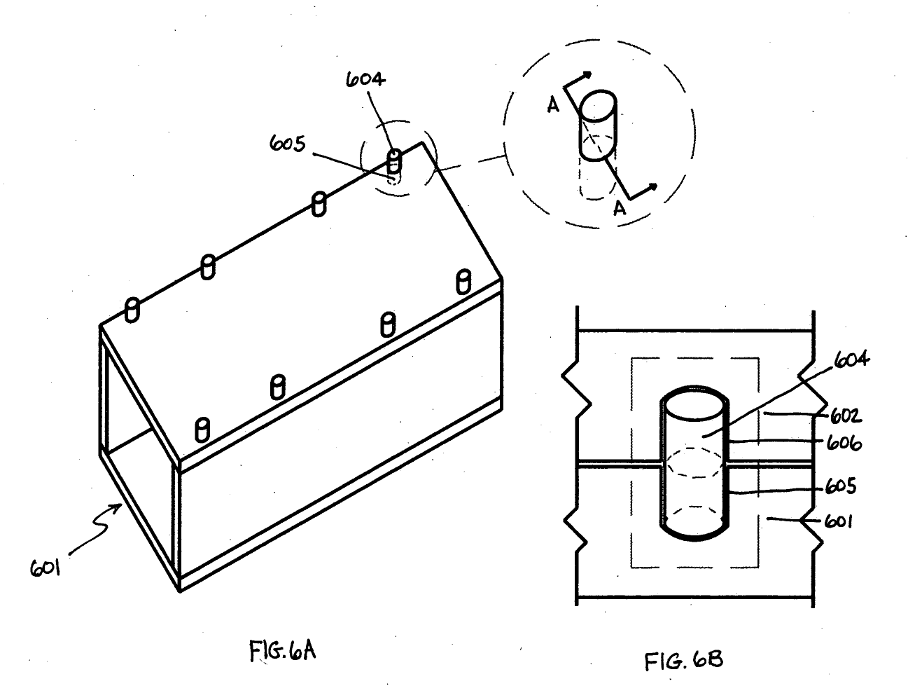

An (first) interment container may also comprise a protrusion(s) configured or positioned to align, engage, or couple with a protrusion(s) of another (second) upper, lower, adjacent, or proximate interment container. Referring to FIG. 5A, in another exemplary embodiment, an (first) interment container 520 comprises at least one protrusion 540 configured to align with engage with, or couple to at least one protrusion 541 of another (or second) interment container 521. Optionally, a floor or supporting surface 550 comprises corresponding protrusions 551 configured to align with or engage with at least one protrusion 542 of at least one interment container 520. The supporting surface 550 may be optionally configured to align with or engage with at least one protrusion of any interment container included in a first row of interment containers. Referring to FIG. 5B, in an additional exemplary embodiment, interment containers 570, 571, 572, 573, 574 are arranged in an exemplary repeating cell pattern. The interment container 570 comprises at least one protrusion 580, 583 configured to align with, engage with, or couple to a plurality of interment container 571, 572 protrusions 581, 582. This exemplary embodiment of at least one interment container 570 protrusion 580, 583 configured to align with a plurality of interment container 571, 572 protrusions 581, 582 may also be described as at least one interment container 570 protrusion 580, 583 configured to align, engage or couple to at least one indentation 595, 596.

Sidewalls or side portions of an interment container may also comprise a protrusion or an indentation. Referring again to FIG. 5B, other exemplary embodiments of an interment container 570 comprise a side portion or side surface having at least one protrusion 590, bump, raised, or elevated feature, or at least one indentation 591, channel, or depression feature. A side protrusion 590 or side indentation 591 is configured or positioned to align, engage, mate, or couple with a corresponding side indentation 592 or side protrusion 593 of an adjacent interment container 573. Similarly, an interment container may comprise a protrusion feature or indentation feature on any area or surface of the container, such as an approximate corner area to align, engage, mate, or couple proximate interment containers.

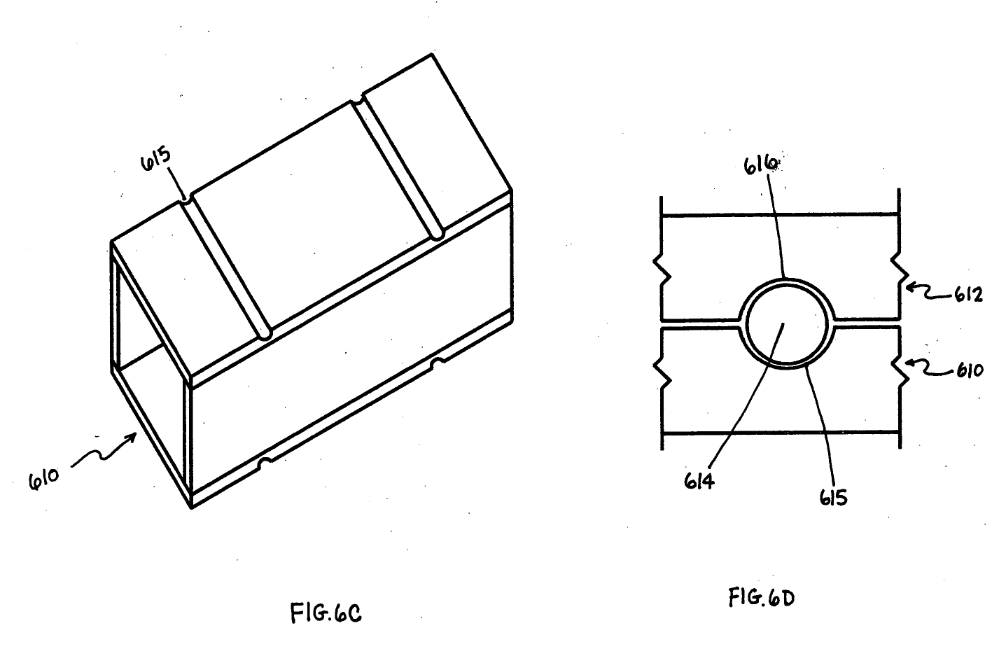

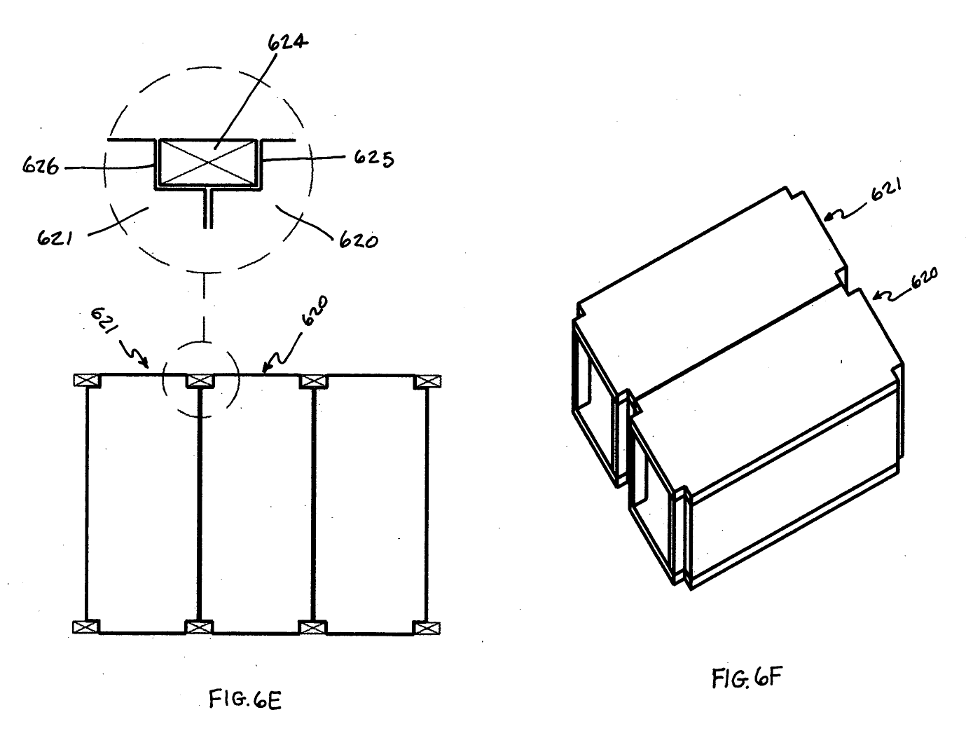

Inserts, keys, or intermediate members may be used to approximately align, engage, inter-engage, couple, or interlock interment container indentations, channels, or depression features. Referring to FIGS. 6A-B, another exemplary embodiment of an interment container 601 comprises at least one indentation 605 configured to align with a corresponding indentation 606 of another interment container 602. A key, insert, or intermediate member 604 approximately engages or fits into indentations 605, 606 of each adjacent, upper, lower, or proximate interment container 601, 602. Referring to FIGS. 6C-D, an indentation 615 that spans the width, length, or height of an interment container 610 is also embodied. A key, insert, or intermediate member 614 (not shown in FIG. 6D) is configured to approximately align with, engage, couple, or fit into indentation 615, and the indentation 616 of another interment container. Referring to the exemplary embodiment of FIGS. 6E-F, a key, insert, or intermediate member 624 approximately aligns with, engages, couples to, or fits into indentations 625, 626 of adjacent, upper, lower, or proximate interment containers 620, 621. This particular interment container embodiment comprises the indentations 625, 626 located on or proximate to a corner of each of the interment containers 620, 621 wherein the indentations 625, 626 also span the height of the interment containers 620, 621.

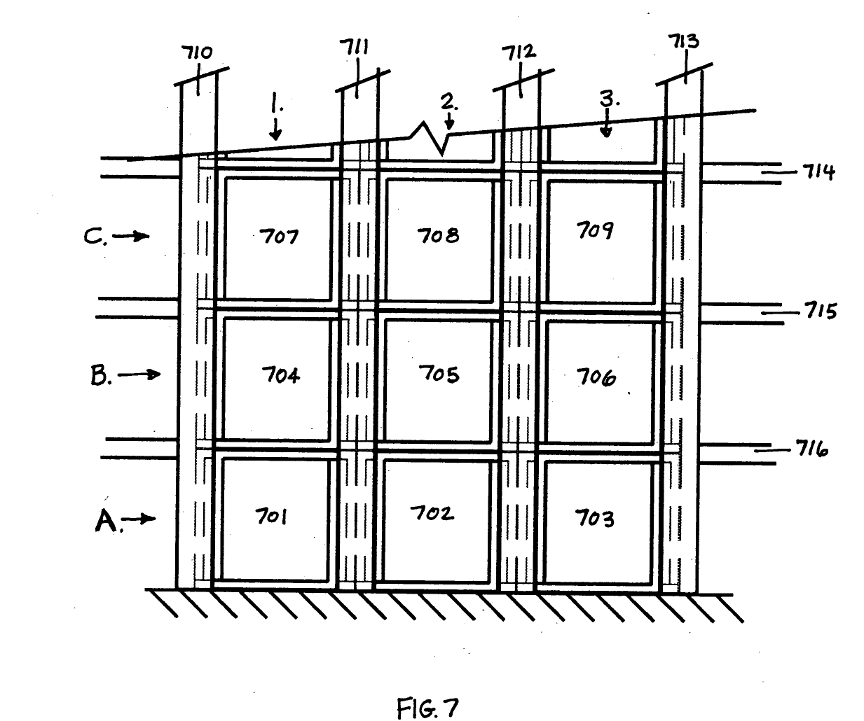

In addition, inserts, keys, or intermediate members may optionally be of sufficient dimension, length, width, or height, to span more than one interment container. Referring to FIG. 7, the exemplary embodiments of interment containers shown incorporate features described in FIGS. 6C-F. The plurality of interment containers 701-709 are arranged or configured into rows A, B, C and into columns 1, 2, 3. At least one key, insert, or intermediate member 710-716 is configured to align, engage, couple, inter-engage, or interlock the plurality of interment containers 701-709. The intermediate members 710-716 may optionally span a distance greater than one interment container dimension, such as the full height, width, or length of the interment container. An intermediate member is configured vertically (710-713) or horizontally (714-716), or optionally at an approximate diagonal (not shown), to assist in the stabilization of a row, column, or a repeating cell pattern of interment containers 701-709. In addition, an intermediate member may be configured in a pattern or shape, for example in a folded or discontinuous shape, to align with an exemplary repeating cell pattern. In one example, referring back to FIG. 5B, an intermediate member may be configured to align, engage, or fit between adjoining sidewalls and/or between upper and lower members, and/or between other portions of the interment containers. Referring again to FIG. 7, in another exemplary embodiment, an insert, key, or intermediate member 710-716 may be optionally extended and attached to or coupled to a structure or other stabilizing item (not shown) such as a column, a wall, a floor, a support beam, or a stabilizing member.

Existing interment containers that are modified to comprise at least one protrusion feature or indentation feature configured to align, engage, couple, or inter-lock with at least one protrusion feature or indentation feature of another interment container are considered to be equivalent embodiments. Generally an equivalent feature may be provided by either adding or removing material to or from an existing interment container, or by adding, adhering, bonding, or coupling additional members to an existing interment container. Referring to FIGS. 3G-H, existing interment containers 373, 383 may be fitted or modified to optionally comprise any or all of the exemplary engaging, aligning, coupling, or inter-locking protrusion features or indentation features 371, 372, 374, 381, 382, 384 of added material or members 374, 375, 376, 385, 386, 387.

The present invention is not to be limited in scope by the specific embodiments described herein. Indeed, various modifications of the invention in addition to those described herein will become apparent to those skilled in the art from the foregoing description and accompanying figures. For example, the interment container or portions of the interment container may be constructed using synthetic resins, wood, concrete, rebar, thermal plastics, or equivalent materials. Also, flanges, fasteners, apertures, bolts, u-shaped channels with gasket, chemical solvents, adhesives, or chemical bonding agents may be used to seal, bond, or attach various members to form an interment container. In addition, existing interment containers may be modified to Those skilled in the art will also recognize, or be able to ascertain using no more than routine experimentation, many equivalents to the specific embodiments of the invention specifically described herein. Such modifications and equivalents are intended to be encompassed by and to fall within the scope of the appended claims.

We claim:

1. An interment container comprising:
a recess or cavity dimensionally and structurally configured to contain or store a coffin or a casket containing a deceased body; and
at least one protrusion or indentation, the protrusion or indentation being configured to align with at least one corresponding protrusion or indentation of at least one other interment container.

2. The interment container of claim 1, wherein the interment container comprises a plurality of portions, partitions, or members which when engaged, fit, or coupled together, cooperate to define an internal recess or internal cavity that is of sufficient size to receive the remains of a deceased body, a coffin or a casket.

3. A crypt or mausoleum comprising a plurality of interment containers as claimed in claim 1, the plurality of interment containers being arranged into rows, columns, or arranging a repeating cell pattern.

4. The interment container of claim 1 wherein a plurality of interment containers are arranged in a row, arranged in a column, or arranged in a repeating cell pattern of interment containers, and at least one protrusion or indentation of the interment container aligns with or engages with at least one indentation or protrusion of the other interment container.

5. The interment container of claim 1 wherein the alignment of a protrusion or indentation is configured to resist or reduce movement between the interment containers.

6. The interment container of claim 1 wherein the interment container comprises a protrusion configured to align with or engage with a corresponding indentation of the other interment container.

7. The interment container of claim 1 wherein the interment container comprises an indentation configured to align with or engage with a corresponding protrusion of the other interment container.

8. The interment container of claim 1 wherein the interment container comprises a protrusion configured to align with or engage with a corresponding protrusion of the other interment container.

9. The interment container of claim 1 wherein at least one interment container protrusion or indentation aligns with or engages with at least one corresponding indention or protrusion of a supporting surface or floor.

10. The interment container of claim 1 wherein at least one interment container protrusion or indentation aligns with or engages with at least one corresponding indention or protrusion of an optional member.

11. The interment container of claim 10 wherein the optional member is coupled to a structure, a stabilizing item, or a stabilizing member.

12. The interment container of claim 1 wherein the interment container comprises an indentation configured to engage with a key or intermediate member; the key or intermediate member also being configured to engage with a corresponding indentation of the other interment container.

13. The interment container of claim 12 wherein the intermediate member dimensionally spans more than one interment container.

14. The interment container of claim 12 wherein the intermediate member horizontally spans more than one interment container.

15. The interment container of claim 12 wherein the intermediate member vertically spans more than one interment container.

16. The interment container of claim 12 wherein the intermediate member length diagonally spans a plurality of interment containers.

17. The interment container of claim 12 wherein the intermediate member is coupled to a structure, stabilizing item, or a stabilizing member.

18. The interment container of claim 1 wherein the at least one protrusion or indentation is located on an upper portion of the interment container, the corresponding indention or protrusion is located on a lower portion of the other interment container, and the interment containers are configured to be stacked or arranged into a column of interment containers.

19. The interment container of claim 1 wherein the at least one protrusion or indentation is located on a side or portion of the interment container, the corresponding indention or protrusion is located on a side portion of the other interment container, and the interment containers are configured to be arranged adjacently or in a row of interment containers.

20. The interment container of claim 1 wherein the at least one protrusion or indentation is approximately located on a corner portion of the interment container, and the corresponding indention or protrusion is approximately located on a corner portion of the other interment container.

21. The interment container of claim 1 wherein the at least one protrusion or indentation configured to align with at least one corresponding indention or protrusion on of the other interment container is provided or enabled by modifying an existing interment container.

22. A crypt, mausoleum, or interment area comprising:
a plurality of interment containers arranged in a row, arranged in a column, or arranged into a repeating cell pattern of interment containers, each interment container comprising a recess or cavity dimensionally and structurally configured to receive and store a coffin or a casket containing a deceased body; and
at least one internment container of the plurality of interment containers comprising at least one protrusion or indentation, the protrusion or indentation being configured to align with at least one corresponding protrusion or indentation of at least one other interment container

23. The crypt, mausoleum, or interment storage area of claim 22, wherein at least one of the plurality of interment containers comprises a plurality of portions, partitions, or members which when engaged, fit, or coupled together, cooperate to define an internal recess or internal cavity that is of sufficient size to receive and store the coffin or casket.

24. The crypt, mausoleum, or interment storage area of claim 22 wherein the alignment of a protrusion or indentation is configured to resist or reduce movement between the interment containers.

25. The crypt, mausoleum, or interment storage area of claim 22 wherein at least one of the plurality of interment containers comprise a protrusion configured to engage with a corresponding indentation of the other interment container.

26. The crypt, mausoleum, or interment storage area of claim 22 wherein at least one of the plurality of interment containers comprise an indentation configured to engage with a corresponding protrusion of the other interment container.

27. The crypt, mausoleum, or interment storage area of claim 22 wherein at least one of the plurality of interment containers comprise an indentation configured to engage with a key or intermediate member; the intermediate member also being configured to engage with a corresponding indentation of the other interment container.

28. The crypt, mausoleum, or interment storage area of claim 27 wherein the intermediate member dimensionally spans more than one interment container.

29. The crypt, mausoleum, or interment storage area of claim 28 wherein the intermediate member horizontally spans more than one interment container.

30. The crypt, mausoleum, or interment storage area of claim 28 wherein the intermediate member vertically spans more than one interment container.

31. The crypt, mausoleum, or interment storage area of claim 22 wherein the at least one protrusion or indentation is located on an upper portion of at least one of the plurality of interment containers, and the corresponding indention or protrusion is located on a lower portion of at least one upper or lower interment container.

32. The crypt, mausoleum, or interment storage area of claim 22 wherein the at least one protrusion or indentation is located on a side portion of at least one of the plurality of interment containers, and the corresponding indention or protrusion is located on a side portion of at least one other adjacent interment container.

33. The crypt, mausoleum, or interment storage area of claim 22 wherein the at least one protrusion or indentation is located on a corner portion of the at least one of the plurality of interment containers, and the corresponding indention or protrusion is located on a corner portion of at least one other interment container.

34. The crypt, mausoleum, or interment storage area of claim 22 wherein the at least one protrusion or indentation configured to align with at least one corresponding protrusion or indentation of at least one other interment container is provided or enabled by modifying at least one existing interment container.

35. A method of constructing a crypt, mausoleum, or interment area, the method comprising the steps of:
providing a plurality of interment containers, each interment container comprising a recess or cavity dimensionally and structurally configured to contain or store a coffin, casket, or vessel containing a deceased body, each interment container further comprising at least one protrusion or indentation, the protrusion or indentation being configured to align with at least one corresponding indention or protrusion of at least one other interment container; and
arranging the plurality of interment containers into a repeating cell structure of interment containers configured such that at least one protrusion or indentation of a first interment container aligns with or engages with at least one protrusion or indentation of a second interment container.

36. The method of constructing a crypt, mausoleum, or interment area of claim 1 wherein arranging the plurality of interment containers into a repeating cell structure comprises arranging the plurality of interment containers into an array of rows and columns.

37. The method of constructing a crypt, mausoleum, or interment area of claim 1 further comprising aligning or engaging a key or intermediate member with at least one indentation of a first interment container, and also aligning or engaging the key or intermediate member with at least one indentation of a second interment container.

38. The method of constructing a crypt, mausoleum, or interment area of claim 1 further comprising aligning or engaging a key or intermediate member with at least one indentation of a first interment container, and also aligning or engaging the key or intermediate member with at least one indentation of a second interment container, wherein the key or intermediate member dimensionally spans more than one interment container.

39. The method of constructing a crypt, mausoleum, or interment area of claim 1 further comprising aligning or engaging a key or intermediate member with at least one indentation of a first interment container, and also aligning or engaging the key or intermediate member with at least one indentation of a second interment container, wherein the key or intermediate member horizontally spans more than one interment container.

40. The method of constructing a crypt, mausoleum, or interment area of claim 1 further comprising aligning or engaging a key or intermediate member with at least one indentation of a first interment container, and also aligning or engaging the key or intermediate member with at least one indentation of a second interment container, wherein the key or intermediate member vertically spans more than one interment container.

41. The method of constructing a crypt, mausoleum, or interment area of claim 1 further comprising modifying a plurality of interment containers, the modification adding at least one protrusion or indentation to at least two interment containers, the protrusion(s) or indentation(s) being configured to align with at least one corresponding indention or protrusion of at least one other interment container.

42. The method of constructing a crypt, mausoleum, or interment area of claim 1 further comprising placing a casket, coffin, or vessel containing deceased remains within the interior, recess, or cavity of the interment container.
